(19) United States
(12) Patent Application Publication
(10) Pub. No.: US 2020/0089704 A1
(43) Pub. Date: Mar. 19, 2020

(54) System and Method for Determining Nutritional Information from a Restaurant Menu

(71) Applicant: Michael Gayed, Brooklyn, NY (US)

(72) Inventor: Michael Gayed, Brooklyn, NY (US)

(21) Appl. No.: 16/563,880

(22) Filed: Sep. 8, 2019

Related U.S. Application Data
(60) Provisional application No. 62/732,425, filed on Sep. 17, 2018.

(51) Int. Cl. G06F 16/583; H04W 4/20; G06F 16/532; G06F 16/51; G06F 16/538; G06F 16/953

(52) U.S. Cl. CPC G06F 16/5846; H04W 4/20; G06F 16/953; G06F 16/51; G06F 16/538; G06F 16/532

(57) ABSTRACT

A method of determining the nutritional content of a menu item is described. The method includes receiving from a restaurant patron's camera an image of at least a portion of a restaurant menu and converting, using an optical character recognition (OCR) algorithm, at least portions of the image to text. The method also includes identifying menu dishes from the text using a matching algorithm with a database of dishes. Further, the method includes sending to a mobile device of a user the menu items identified and receiving from the user a selected menu item.

### REFERENCE TO RELATED APPLICATIONS

This application claims priority to U.S. Provisional Application No. 62/732,425 entitled System and Method for Determining Nutritional Information from a Restaurant Menu to Inventor Michael Gayed, filed on Sep. 17, 2018.

### BACKGROUND

Conventionally, there is interest in dieting apps and other computer programs which help people get information on and maintain a variety of diets. There are also many different diets which people are interested in. Further, many people eat outside the home at restaurants and the like for one or more meals per day. Because of this, people have difficulty staying on their particular diet because they don't know where to get restaurant dishes that fit their diet or they do not know the nutritional content of the food that they receive from restaurants. Therefore, there is a need for a way in which to search for foods which are in line with their diets at nearby restaurants. What would further be desirable is a mobile application which could search for such foods at restaurants nearby and help the user in making informed restaurant choices. To support such a mobile application there is a need and desire for a method and system for determining nutritional information from a restaurant menu. There is also a need for users of the mobile application to be able to add to a nutritional database for restaurant foods that may be used by other users of the mobile app.

In addition to the illustrative aspects, embodiments, and features described above, further aspects, embodiments, and features will become apparent by reference to the drawings and the following detailed description.

### SUMMARY

An exemplary embodiment relates to a method of determining the nutritional content of a menu item. The method includes receiving from a restaurant patron's camera an image of at least a portion of a restaurant menu and converting, using an optical character recognition (OCR) algorithm, at least portions of the image to text. The method also includes identifying menu dishes from the text using a matching algorithm with a database of dishes. Further, the method includes sending to a mobile device of a user the menu items identified and receiving from the user a selected menu item.

Another exemplary embodiment relates to a system for determining the nutritional content of a menu item. The system includes a server for receiving a restaurant patron's camera image of at least a portion of a restaurant menu and an optical character recognition (OCR) program configured to convert at least portions of the image to text. The system also includes a server running a program configured to identify menu dishes from the text using a matching algorithm with a database of dishes. Further the system includes a communication device configured to send to a mobile device of a user, the menu items identified and a display on the mobile device of the user configured to display information related to a selected menu item.

Yet another exemplary embodiment relates to a system of determining the nutritional content of a menu item. The system includes a means for receiving from a restaurant patron's camera an image of at least a portion of a restaurant menu and a means for converting, using an optical character recognition (OCR) algorithm, at least portions of the image to text. The system further includes a means for identifying menu dishes from the text using a matching algorithm with a database of dishes. Further still, the system includes a means for sending to a mobile device of a user the menu items identified and a means for receiving from the user a selected menu item.

In addition to the foregoing, other system aspects are described in the claims, drawings, and text forming a part of the disclosure set forth herein. The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the disclosures set forth herein.

### BRIEF DESCRIPTION OF THE DRAWINGS

FIG. 1 is a depiction of a networking system including a plurality of servers and mobile devices connected to a communications network.

FIG. 2 is a depiction of a network configuration for the mobile app.

The use of the same symbols in different drawings typically indicates similar or identical items unless context dictates otherwise.

### DETAILED DESCRIPTION

In the following detailed description, reference is made to the accompanying drawings, which form a part thereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

In accordance with an exemplary embodiment, a mobile application may be used to help keep a user's particular diet on track. The mobile application may aid in finding dishes that are suited to the user's diet at nearby restaurants. People on diets are often tempted by restaurant menu items when they are out. A mobile app which provides ways of finding healthy, local menu options which are in line with that particular diet may be very useful to curb such temptation. Exemplary diets may include but are not limited to low calorie, low carb, high protein, high fiber, low fat, balanced, vegan, vegetarian, gluten-free, Atkins, etc. Using a mobile application which provides menu item suggestions from nearby restaurants that fit the user's diet make it easy for users to stay on their diet. Also, in an exemplary embodiment, it may be desirable for a user to be connected to a network of dieters who can share their diet meal plans, favorite restaurants, and dishes, and healthy recipes that match with dieting goals. People who are on similar diets may be networked with each other providing an environment of information sharing and motivation.

In an exemplary embodiment, a user using the mobile app will at first set a goal, for example inputting current or target weight. The user may also update their weight at any time while tracking meals. A user may also devise a strategy within the app such as selecting a specific diet that the user is following. The diets maybe any of a number of diets including but not limited to low-carb diets, low calorie diets, the Atkins diet, vegetarian diets, gluten-free diets, vegan diets, etc. Whenever the user is interested in eating at a restaurant, the user may find healthy eats that maintains the user's diet by searching for dishes served at nearby restaurants which fall near or within the constraints of the diet. The dishes maybe saved for later access. The app may also be used for planning upcoming meals from nearby restaurants. The app also provides the ability to identify a recipe that matches a user's diet and optionally may allow checking ingredients in the recipe. The app allows the user to get detailed nutrition information on dishes that interest them. The app also allows the user to track things like calories or carbs eaten during the day. The app may also allow the user to rate and report dishes and restaurants for users of the social network. The app further allows users to share experiences with various dishes or recipes with friends who may be on the same diet as them. In many instances a user of the mobile app is eating at a restaurant that is not part of the current database of nutritional information for the dishes on the menu. Thus, the user is unable to access the nutritional information. In accordance with an exemplary embodiment, a system and method to solve this problem is presented. The exemplary system and method requires that the user use their mobile device to take a picture of or otherwise scan the restaurant's menu. Once scanned in a character recognition algorithm or module converts the photographic or scanned image to text. An algorithm identifies the names of the different dishes on the menu that are available for purchase by the user. The algorithm operatively searches a recipe database and generates matches of the menu items to recipes in the recipe database. Once a best match is made, nutritional information may then be generated for the recipe based on ingredients for the recipe. The nutritional information is communicated back to the user who is still perusing the menu but wished for nutritional information about items on the menu. On the database side, the menu for the restaurant, it's recipe matches and nutritional information are stored as well as information about the restaurant including but not limited to name, location as well as other information that might be gleaned from a web search or other information sources.

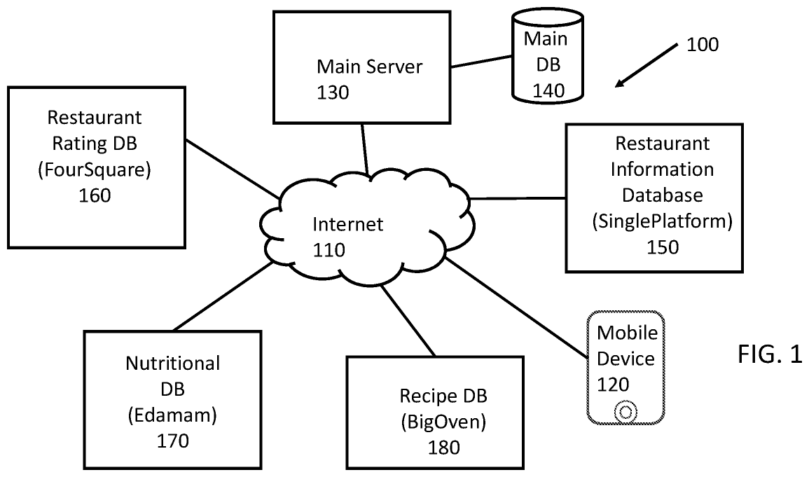

Referring to FIG. 1, a networked system of servers and devices 100 includes the internet 110 as a communication system. The communication system may be any of a variety of communication systems including the internet and cellular phone networks or other communication networks. One or more mobile devices 120 may be connected to the internet through a cellular phone network or WiFi network and running a mobile application thereon. In order to implement the mobile application, the mobile devices connect to a cloud server 130 running the service software. The server software enables a user to carryout searches for dishes at nearby restaurants as well as storing user preferences, accounts, and information and further enabling social networking features. The server software enables storing of restaurant, recipe, nutrition, and user information in a main database 140. The restaurant, recipe, and nutrition information are retrieved from other sources of information including but not limited to a restaurant menu and information database 150 (such as but not limited to SinglePlatform), a restaurant rating database 160 (such as but not limited to FourSquare), and a Nutritional Database 170 (such as but not limited to Edamam). Each of these databases are accessible through the communication network 110 or the like. The databases are harvested for information at regular intervals to maintain a current dataset.

As discussed above according to an exemplary embodiment the feature described in which a user scans a restaurant menu and receives nutritional information may be a part of a comprehensive mobile app which allows for diet tracking, restaurant and dish suggestions, etc. or may stand alone as an application which is used primarily for a user to determine nutritional information from a restaurant menu.

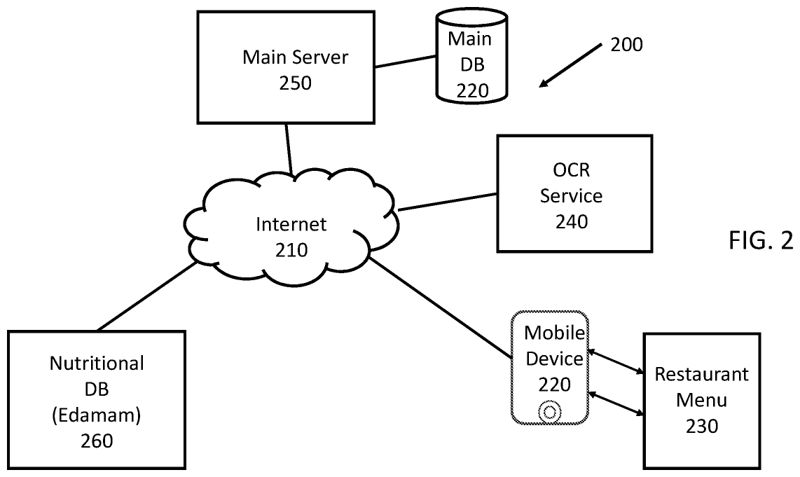

Referring now to FIG. 2 a network configuration 200 for the mobile app is depicted. In an exemplary embodiment, the mobile app runs on a mobile device 220. Mobile device 220 is configured to take a picture of or otherwise scan a restaurant menu 230. Mobile device 220 communicates the scan over Internet 210 or other communication network to an Optical Character Recognition (OCR) service 240. OCR service 240 converts the scan or picture to text and sends that information to a Main Server 250 which runs a matching algorithm that matches the menu items to certain Recipes and Nutritional Information from Nutritional Database 260. In an alternative embodiment once the match is made, the nutritional information is retrieved from Main Database 220. If the information is retrieved from Nutritional Database 260, then, once matched, the Nutritional information is sent back to the main server for storage in a Main database 270 and also to the mobile device whose user can use the information in making their selection from the menu.

In accordance with an exemplary embodiment a user identifies either automatically by the mobile app or by manually searching for a restaurant that the restaurant's nutritional information is not part of a database already accessed by the mobile app. At that point the general algorithm for the feature may include the following steps:

1. A user is at a restaurant and takes a picture of the menu.

2. The picture of the menu is passed through an Optical Character Recognition (OCR) algorithm which converts the menu to text. In one exemplary embodiment Google's Cloud Vision OCR service may be used for the conversion. In this arrangement the mobile device directly call the Cloud Vision API to carry out the OCR. In accordance with one exemplary embodiment, each line of text is detected and then the OCR is done on each line of text.

3. The recognized text is then cleaned to help identify the menu dishes. The cleaning may, for example include but is not limited to the following:

Ignore any line of text the contains a “,”

Ignore any line of text with common words like “menu”, “appetizer”, “breakfast”, “cocktails”, “lunch”, “dinner”

Strip out all numbers from the text

Strip out all punctuation from the text. (all “.”, “;”, “:”, etc. . . . )

4. A matching algorithm which may be as simple as a “Contains” match against the Edamam (Nutritional) database, for each line of text detected attempt to find any of the Edamam dish names within it using a simple “Contains” type match. It is understood that any relevant type of matching algorithm may be used without departing from the scope of the invention.

5. The results may be displayed to the user in a two-column table, in for example, the following manner, although it is understood that any type of formatting may be applied:

Column 1: Displays the OCR output of each line of text from the Menu

Column 2: Displays the best matched Edamam Recipe that we matched with it.

Column 3: Displays the nutritional-labels that are associated with that Edamam Recipe from a database for the mobile application

6. Provide within the mobile app an export button which will export the above table into a CSV that can be emailed using a built-in activity view controller.

The above features and displayed information and format are exemplary, as any of a variety of these features may be used without departing from the scope of the invention.

In accordance with an exemplary embodiment, variations may be made to the matching algorithm based on desired performance. For example, an alternative “Contains” matching which may operate as follows:

A. For every menu that is scanned, process all of the menu names in the Edamam database, trying to match an Edamam database item to a string scanned in. This is an attempt to contains match Edamam recipe Y within scanned menu text X, not the other way around.

B. This process may require at least 16 k comparisons for every menu scanned, this is done as quickly as possible using in-memory comparisons.

C. In an alternative embodiment, provide an option to switch between “Contains” matching versus other matching algorithms.

In an exemplary embodiment by users of the mobile app scanning menus, the database of recipes may be enlarged. It is thus desirable to integrate the ability to compare scanned dishes against the expanded set of Edamam recipes and provide an option to switch between the original set and the expanded set.

In an exemplary embodiment it may be desirable to enable the user to turn-off/on the “comma” filtering rule which was described earlier. When “comma” filtering is turned off then the app will process lines with a comma, however the commas will be stripped out during the matching phase as per Rule 3 above.

The user interface may be very important for creating a good user experience. In exemplary embodiment an options page may be used, accessible via a “gear” icon in the nav bar, which will expose the following options:

Switch between “Contains” and other matching algorithms.

Switch between using the existing set of 16 k Edamam dishes versus using the expanded set of 40 k Edamam dishes.

Switch on/off the “comma” filtering rule.

Upon navigating back to the main view controller by the user, any changes done in the options screen should then be applied to the next scan done in the app.

In accordance with an exemplary embodiment, for the “contains” search, for each menu item m, use contains matching to create a candidate set of matches from the Edamam database. Next, use fuzzy searching to reduce the set of matches for each m and choose the most applicable recipe from Edamam to return as the match for m. If, for example, menu items: A,B,C,D and our Edamam DB has recipes X,Y,Z. assume the following contains matches to each menu item:

A˜=X,Y

B˜=Y

C˜=Z

Then use Fuzzy matching to pick the better suited of X,Y.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. A method of determining the nutritional content of a menu item, comprising:
receiving from a restaurant patron's camera an image of at least a portion of a restaurant menu;
converting, using an optical character recognition (OCR) algorithm, at least portions of the image to text;
identifying menu dishes from the text using a matching algorithm with a database of dishes;
sending to a mobile device of a user the menu items identified; and
receiving from the user a selected menu item.

2. The method of claim 1, further comprising:
matching the menu item with a similar dish in a nutritional database.

3. The method of claim 2, further comprising:
retrieving nutritional information for the menu item from the nutritional database.

4. The method of claim 3, further comprising:
sending the nutritional information to the user.

5. The method of claim 1, further comprising:
categorizing the dish with one or more diets based on the nutritional information.

6. The method of claim 1, further comprising:
storing the dish information in a database.

7. The method of claim 6, wherein the dish information includes nutritional information and restaurant information.

8. A system for determining the nutritional content of a menu item, comprising:
a server for receiving a restaurant patron's camera image of at least a portion of a restaurant menu;
an optical character recognition (OCR) program configured to convert at least portions of the image to text;
a server running a program configured to identify menu dishes from the text using a matching algorithm with a database of dishes;
a communication device configured to send to a mobile device of a user, the menu items identified; and
a display on the mobile device of the user configured to display information related to a selected menu item.

9. The system of claim 8, further comprising:
a server computer program configured to match the menu item with a similar dish in a nutritional database.

10. The system of claim 9, further comprising:
a server computer program configured to retrieve nutritional information for the menu item from the nutritional database.

11. The system of claim 10, further comprising:
a communication device configured to send the nutritional information to the user.

12. The system of claim 8, further comprising:
a server computer running a program configured to categorize the dish with one or more diets based on the nutritional information.

13. The system of claim 8, further comprising:
a database configured to store the dish information.

14. The system of claim 6, wherein the dish information includes nutritional information and restaurant information.

15. A system of determining the nutritional content of a menu item, comprising:
a means for receiving from a restaurant patron's camera an image of at least a portion of a restaurant menu;
a means for converting, using an optical character recognition (OCR) algorithm, at least portions of the image to text;
a means for identifying menu dishes from the text using a matching algorithm with a database of dishes;
a means for sending to a mobile device of a user the menu items identified; and
a means for receiving from the user a selected menu item.

16. The method of claim 1, further comprising:
a means for matching the menu item with a similar dish in a nutritional database.

17. The method of claim 2, further comprising:
a means for retrieving nutritional information for the menu item from the nutritional database.

18. The method of claim 3, further comprising:
a means for sending the nutritional information to the user.

19. The method of claim 1, further comprising:
a means for categorizing the dish with one or more diets based on the nutritional information.

20. The method of claim 1, further comprising:
a means for storing the dish information in a database.
